(19) United States
(12) Patent Application Publication
(10) Pub. No.: US 2018/0217351 A1
(43) Pub. Date: Aug. 2, 2018

(54) PROJECTION TYPE IMAGE DISPLAY DEVICE

(71) Applicant: Hitachi Maxell, Ltd., Ibaraki-shi ,Osaka (JP)

(72) Inventors: Akihiro SHIRAISHI, Ibaraki-shi, Osaka (JP); Kazuo SHIKITA, Ibaraki-shi, Osaka (JP); Satoshi NAKAYAMA, Ibaraki-shi, Osaka (JP)

(73) Assignee: Hitachi Maxell, Ltd., Ibaraki-shi, Osaka (JP)

(21) Appl. No.: 15/525,777

(22) PCT Filed: Nov. 14, 2014
(86) PCT No.: PCT/JP2014/080209

§ 371 Date: May 10, 2017

(51) Int. Cl. G02B 7/08; G03B 21/14; G03B 3/12; G02B 7/02

(52) U.S. Cl. CPC G02B 7/08; G02B 7/021; G03B 3/12; G03B 21/142

(57) ABSTRACT

A projection type image display device includes a focus adjusting unit that adjusts a focal position of a projection lens. The projection lens includes a front side lens group and a rear side lens group which are displaceable toward the screen. The focus adjusting unit includes a back focus adjusting unit that adjusts a position of the rear side lens group and a peripheral adjusting unit that adjusts a position of the front side lens group, and the back focus adjusting unit and the peripheral adjusting unit independently adjust the position of the rear side lens group and the position of the front side lens group by individual driving of motors.

### TECHNICAL FIELD

The present invention relates to a projection type image display device which is capable of easily implementing a focus adjustment of a projection lens.

### BACKGROUND ART

In projection type image display devices (projectors) that project video onto screen or the like, a focus adjustment of a projection lens is performed so that a satisfactory video is displayed in accordance with a projection distance to a screen. At this time, a method in which the user manually performs the adjustment has poor workability, and it is desirable to perform the adjustment by an electric (motor-driven) method. Patent Document 1 discloses a configuration in which two adjustment mechanisms of a focus adjustment and a peripheral adjustment of a projection lens are interlocked and driven by one motor.

### CITATION LIST

### Patent Document

Patent Document 1: JP 2013-088652 A

### SUMMARY OF THE INVENTION

### Problems to be Solved by the Invention

When a projection distance to a screen varies greatly depending on an installation state of the projection type image display device, an optional lens for a short throw or a long throw is installed and used as the projection lens. A standard lens can be covered with one adjustment mechanism, but particularly, in the case of the optional lens for the short throw, two adjustment mechanisms of a focus adjustment and a peripheral adjustment are necessary to support various projection sizes at a short projection distance. The method in which the two adjustment mechanisms of the focus adjustment and the peripheral adjustment are interlocked which is described in Patent Document 1 is based on the premise that a positional relation between a lens and a display element is substantially the same as a design value. However, in the case of the optional lens, the positional relation between the lens and the display element may deviate from the design value due to a mechanical tolerance or the like that occurs when the user attaches the optional lens to the projector, and thus when the two adjustments are interlocked and performed, it is expected that an adjustment accuracy may be insufficient.

Further, in an adjustment screen of the related art, a focusing pattern (indicator) displayed at the time of adjustment has only one type. For this reason, at the time of focus adjustment and at the time of peripheral adjustment, the user performs the adjustment using the displayed indicator differently, leading to poor workability.

It is an object of the present invention to provide a projection type image display device which is capable of implementing the focus adjustment of the projection lens finely and easily.

### Solutions to Problems

According to the present invention, provided is a projection type image display device that projects a video onto a screen via a projection lens, including: a focus adjusting unit that adjusts a focal position of the projection lens; and a control unit that controls the focus adjusting unit, wherein the projection lens includes a front side lens group and a rear side lens group which are displaceable toward the screen, the focus adjusting unit includes a back focus adjusting unit that adjusts a position of the rear side lens group and a peripheral adjusting unit that adjusts a position of the front side lens group, and the back focus adjusting unit and the peripheral adjusting unit independently adjust the position of the rear side lens group and the position of the front side lens group by individual driving of motors.

Here, the back focus adjusting unit performs a focus adjustment of a first region of the screen onto which video is projected, the peripheral adjusting unit performs a focus adjustment of a second region of the screen onto which video is projected, and the first region is a central portion of the screen, and the second region is a peripheral region of the screen.

Here, the control unit causes a first indicator for adjustment confirmation to be displayed on the first region of the screen at a time of adjustment by the back focus adjusting unit, and the control unit causes a second indicator for adjustment confirmation to be displayed on the second region of the screen at a time of adjustment by the peripheral adjusting unit.

### Effects of the Invention

According to the present invention, the focus adjustment and the peripheral adjustment of the projection lens can be executed independently by an electric method, and thus a fine adjustment can be performed, and an adjustment accuracy is improved. In addition, since a confirmation indicator is displayed for each adjustment region at the time of adjustment, an adjustment task of the user becomes easy.

### BRIEF DESCRIPTION OF THE DRAWINGS

FIG. 1 is a configuration diagram illustrating an example of a projection type image display device 100 according to the present invention.

FIG. 2 is a configuration diagram illustrating an example of a projection lens 17.

FIG. 3 is a diagram illustrating an example of a focus adjustment screen.

### MODE FOR CARRYING OUT THE INVENTION

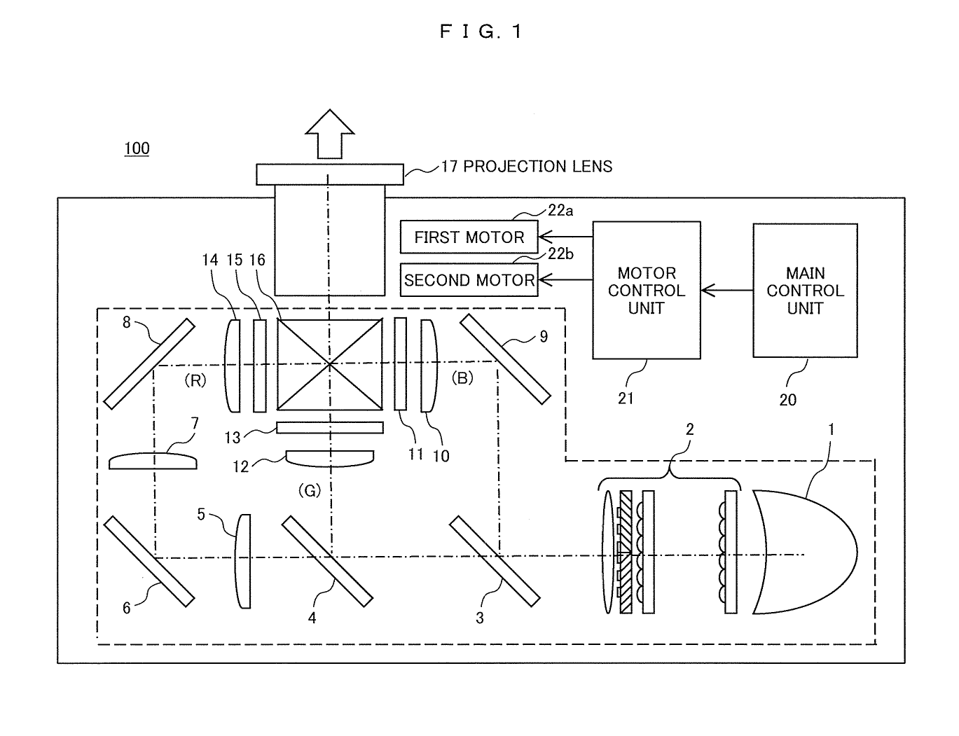

Hereinafter, an exemplary embodiment of the present invention will be described with reference to the appended drawings. FIG. 1 is a configuration diagram illustrating an example of a projection type image display device 100 according to the present invention. First, an optical system will be described. Here, liquid crystal panels corresponding to three colors (R, G, and B) are used as a video display element. Illumination light emitted from a lamp (light source) 1 becomes uniform illumination light through a fly eye lens unit 2 and moves to a dichroic optical system. The dichroic optical system separates the illumination light into R light, G light, and B light and guides them to corresponding liquid crystal panels. The B light is reflected by a dichroic mirror 3 and incident on a B light liquid crystal panel 11 via a reflecting mirror 9 and a condenser lens 10. The G light and the R light are separated by a dichroic mirror 4 after passing through the dichroic mirror 3. The G light is reflected by the dichroic mirror 4, passes through a condenser lens 12, and is incident on a G light liquid crystal panel 13. The R light passes through the dichroic mirror 4 and is incident on the R light liquid crystal panel 15 via relay lenses 5 and 7, reflecting mirrors 6 and 8, and a condenser lens 14.

Each of the liquid crystal panels 11, 13, and 15 receives a drive signal corresponding to a video signal to be displayed from a panel driving circuit (not illustrated), modulates each incident color light in accordance with each video signal, and forms an optical image of each color light. The optical image of each color light is incident on a cross dichroic prism 16. In the cross dichroic prism 16, a dichroic film that reflects the B light and a dichroic film that reflects the R light are formed in a substantially X shape. The B light and the R light which are incident from the liquid crystal panel 11 and 15 are reflected by the B light dichroic film and the R light dichroic film, respectively. The G light which is incident from the liquid crystal panel 13 passes through the dichroic films. As a result, the optical images of the respective color lights are synthesized and emitted as color video light. The color video light emitted from the cross dichroic prism 16 is incident on a projection lens 17 and projected on a screen (not illustrated).

Next, a control system will be described. As will be described later, the projection lens 17 has a front side lens group and a rear side lens group, and a lens position can be independently adjusted in the projection direction by an electric method. In other words, a first motor 22a is a drive source for adjusting the position of the front side lens group and a second motor 22b is a drive source for adjusting the position of the rear side lens group. A motor control unit 21 supplies a drive signal according to a displacement amount to each of the motors 22a and 22b.

A main control unit 20 controls an entire device including the motor control unit 21. Particularly, in the present embodiment, a user operation signal is received by a remote controller (not illustrated) or the like, and the first and second motors 22a and 22b are driven through the motor control unit 21 in accordance with the user operation. Accordingly, the positions of the front side lens group and the rear side lens group in the projection lens 17 are adjusted. Further, the main control unit 20 generates a video signal of a focusing pattern (indicator) to be displayed on an adjustment screen. Then, the video signal is supplied to each of the liquid crystal panels 11, 13, and 15 via a panel drive circuit in accordance with an adjustment timing of the user.

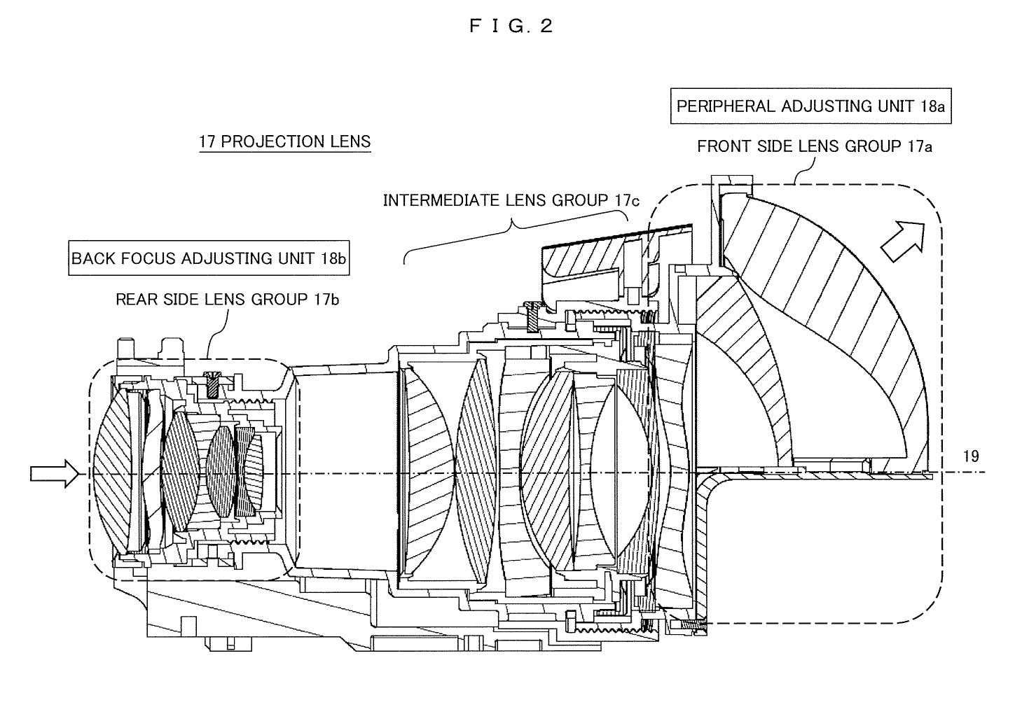

FIG. 2 is a configuration diagram illustrating an example of the projection lens 17. The projection lens 17 includes a plurality of lens groups and is configured with a front side lens group 17a on a screen side, a rear side lens group 17b on a side of the cross dichroic prism 16, and an intermediate lens group 17c interposed therebetween. Each lens group is configured of one or more lenses. In the present example, in order to implement oblique projection onto the screen, an arrangement and a shape of the front side lens group 17a on the screen side are axially asymmetrical with respect to an optical axis 19, and occurred distortion is corrected through the oblique projection.

In the focus adjustment, a focal position is adjusted to a screen position by displacing the lens group of the projection lens in a front-back direction (an optical axis direction). In such focus adjustment, since a phenomenon that an end portion of a projected video is curved or blurs due to a focal length from the lens group, an accurate adjustment is performed by the peripheral adjustment of further correcting the curvature or the blur. Hereinafter, the adjustment of the focal position is referred to as a “back focus adjustment” to be distinguished from the peripheral adjustment.

The back focus adjusting unit 18b displaces the rear side lens group 17b among the lens groups, and the peripheral adjusting unit 18a displaces the front side lens group 17a. Each of the adjusting units 18a and 18b has an adjustment mechanism for transferring drive force from the motors 22a and 22b through a gear or the like. The back focus adjusting unit 18b may simultaneously displace both the rear side lens group 17b and the front side lens group 17a, and the peripheral adjusting unit 18a may displace only the front side lens group 17a.

The back focus adjusting unit 18b displaces the rear side lens group 17b and performs a focus adjustment of a central portion of a projection video screen. On the other hand, the peripheral adjusting unit 18a displaces the front side lens group 17a and performs a focus adjustment of a periphery of the projection video screen (curvature correction). Here, as described above, in the case of the oblique projection, a projection direction has an angle of attack above the optical axis direction of the projection lens 17 of the lens. Therefore, in in the screen (effective screen) onto which a video is actually projected, a region affected by distortion of the lens peripheral portion is only an upper end portion of the screen.

According to the present embodiment, since the back focus adjustment and the peripheral adjustment in the projection lens 17 can be independently performed by driving the respective motors 22a and 22b, the fine adjustment can be performed, and thus the adjustment accuracy is improved.

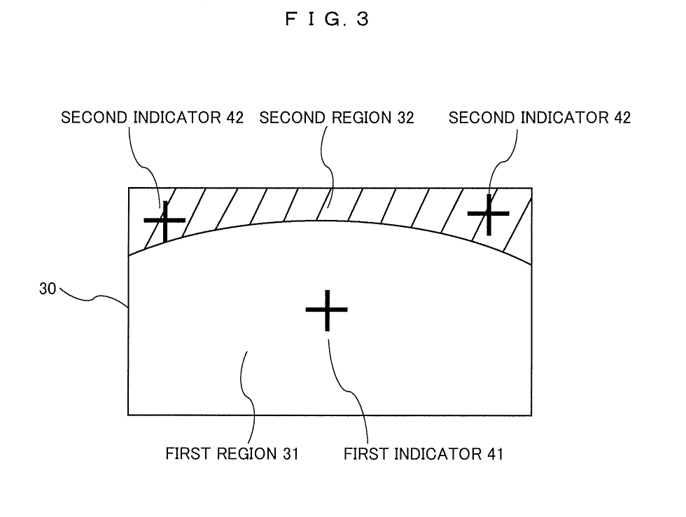

FIG. 3 is a diagram illustrating an example of a focus adjustment screen. At the time of the focus adjustment, an adjustment confirmation pattern (indicator) is displayed on the adjustment screen on the screen in accordance with a timing at which the user performs the adjustment operation (for example, an operation on a remote controller button). The user performs the focus adjustment by operating the adjustment button of the remote controller while viewing the indicator displayed on the adjustment screen.

In the present embodiment, an adjustment screen 30 is divided into a first region 31 and a second region 32, and an indicator is displayed for each rejection individually. In the first region 31 of the screen central portion, the back focus adjustment is performed by displacing the rear side lens group 17b. Therefore, a first indicator 41 for adjustment confirmation is displayed in the first region 31 (the screen central portion). In the second region 32 of the screen peripheral part (the upper end side in this example), the peripheral adjustment is performed by displacing the front side lens group 17a. Therefore, a second indicator 42 for adjustment confirmation is displayed in the second region 32 (the screen peripheral part). In this example, two second indicators 42 are displayed on the left and right in view of right and left balance of the screen. In this example, the first and second indicators 41 and 42 are the same pattern (cross pattern) but may be different patterns.

The first and second indicators are not displayed at the same time but displayed in accordance with the timing of the adjustment operation of the user. In other words, only the first indicator 41 is displayed at the time of adjustment of the first region 31 (at the time of the back focus adjustment), and only the second indicator 42 is displayed at the time of adjustment of the second region 32 (at the time of the peripheral adjustment). Thus, the user can perform the adjustment while paying attention to the displayed indicator and need not consider whether a current adjustment is the back focus adjustment or the peripheral adjustment, and thus convenience of the user is improved.

In the above embodiment, the following functions can be added. Since a lens ID indicating a type of lens is allocated to the projection lens, the main control unit 20 reads the lens ID and identifies a type of projection lens (optional lens) which is installed. The main control unit 20 causes the type (name) of installed lens to be displayed on the adjustment screen to display on the basis of a lens identification result, determines whether or not it is necessary to perform the focus adjustment, and causes a necessary indicator to be displayed on the screen. Alternatively, an indicator display method (a pattern shape, a display position, the number of displays, or the like) is switched on the basis of the lens identification result. When such functions are added, it is possible to provide the projection type image display device capable of appropriately supporting various types of optional lenses.

### REFERENCE SIGNS LIST

1 lamp (light source)
11, 13, 15 liquid crystal panel
16 cross dichroic prism
17 projection lens
17a front side lens group
17b rear side lens group
17c intermediate lens group
18a peripheral adjusting unit
18b back focus adjusting unit
19 optical axis
20 main control unit
21 motor control unit
22a, 22b motor
30 adjustment screen
31 first region
32 second region
41 first indicator
42 second indicator
100 projection type image display device

1. A projection type image display device that projects a video onto a screen via a projection lens, comprising:
a focus adjusting unit that adjusts a focal position of the projection lens; and
a control unit that controls the focus adjusting unit,
wherein the projection lens includes a front side lens group and a rear side lens group which are displaceable toward the screen,
the focus adjusting unit includes a back focus adjusting unit that adjusts a position of the rear side lens group and a peripheral adjusting unit that adjusts a position of the front side lens group, and
the back focus adjusting unit and the peripheral adjusting unit independently adjust the position of the rear side lens group and the position of the front side lens group by individual driving of motors.

2. The projection type image display device according to claim 1,
wherein the back focus adjusting unit performs a focus adjustment of a first region of the screen onto which video is projected,
the peripheral adjusting unit performs a focus adjustment of a second region of the screen onto which video is projected, and
the first region is a central portion of the screen, and the second region is a peripheral region of the screen.

3. The projection type image display device according to claim 2,
wherein the control unit causes a first indicator for adjustment confirmation to be displayed on the first region of the screen at a time of adjustment by the back focus adjusting unit, and
the control unit causes a second indicator for adjustment confirmation to be displayed on the second region of the screen at a time of adjustment by the peripheral adjusting unit.

4. The projection type image display device according to claim 3,
wherein the control unit identifies a type of the projection lens installed on the projection type image display device and switches a display method of the first indicator or the second indicator on the basis of an identification result.

5. The projection type image display device according to claim 1,
wherein the control unit causes different indicators for adjustment confirmation to be displayed on the screen at a time of adjustment by the back focus adjusting unit and at a time of adjustment by the peripheral adjusting unit.

6. A projection type image display device in which a projection lens is installable,
a light source,
an optical system that guides light emitted from the light source to a display element; and
a control unit that is capable of generating control information for adjusting a focal position of the projection lens,
wherein control of a back focus adjustment of adjusting a position of a rear side lens group of the projection lens and control of a peripheral adjustment of adjusting a position of a front side lens group are able to be performed on the basis of the control information generated by the control unit, and
the back focus adjustment and the peripheral adjustment controlled on the basis of the control information are performed by adjusting the position of the rear side lens group and the position of the front side lens group independently by driving of motors which are installed individually in the projection lens.

7. The projection type image display device according to claim 6,
wherein the control unit causes different indicators for adjustment confirmation to be displayed on the screen at a time of adjustment by the back focus adjusting unit and at a time of adjustment by the peripheral adjusting unit.

8. The projection type image display device according to claim 6,
wherein the back focus adjustment controlled on the basis of the control information is a focus adjustment of a first region of the screen onto which a video is projected,
the peripheral adjustment controlled on the basis of the control information is a focus adjustment of a second region of the screen onto which the video is projected, and
the first region is a central portion of the screen, and the second region is a peripheral region of the screen.

9. The projection type image display device according to claim 8,
wherein the control unit causes a first indicator for adjustment confirmation to be displayed on the first region of the screen at a time of adjustment by the back focus adjusting unit, and
the control unit causes a second indicator for adjustment confirmation to be displayed on the second region of the screen at a time of adjustment by the peripheral adjusting unit.

10. The projection type image display device according to claim 9,
wherein the control unit identifies a type of the projection lens installed on the projection type image display device and switches a display of the first indicator or the second indicator on the basis of an identification result.
